(19) United States
(12) Patent Application Publication
(10) Pub. No.: US 2021/0157338 A1
(43) Pub. Date: May 27, 2021

(54) FLYING BODY CONTROL APPARATUS, FLYING BODY CONTROL METHOD, AND FLYING BODY CONTROL PROGRAM

(71) Applicant: NEC CORPORATION, Tokyo (JP)

(72) Inventor: Tetsuo INOSHITA, Tokyo (JP)

(73) Assignee: NEC CORPORATION, Tokyo (JP)

(21) Appl. No.: 16/641,521

(22) PCT Filed: Aug. 25, 2017
(86) PCT No.: PCT/JP2017/030627

§ 371 Date: Feb. 24, 2020

(51) Int. Cl. G05D 1/10; B64C 39/02

(52) U.S. Cl. CPC G05D 1/102; B64C 39/024; G05D 1/0088; B64C 2201/127; B64C 2201/141

(57) ABSTRACT

A flying body that can more reliably be made to hover at a desired position includes a determiner that determines whether to make the flying body hover, an image capturer that captures a periphery of the flying body, a recorder that records an image captured by the image capturer, and a stop controller that, if it is determined to make the flying body hover, stops the flying body in the air using the image recorded in the recorder and an image captured during flight.

### TECHNICAL FIELD

The present invention relates to a flying body, a flying body control apparatus, a flying body control method, and a flying body control program.

### BACKGROUND ART

In the above technical field, patent literature 1 discloses a technique of performing automatic guidance control of a flying body to a target mark placed on the ground at the time of landing to save the technique and labor of a pilot.

### CITATION LIST

### Patent Literature

Patent literature 1: Japanese Patent Laid-Open No. 2012-71645

### SUMMARY OF THE INVENTION

### Technical Problem

In the technique described in the literature, however, depending on the flight altitude, it may be impossible to accurately visually recognize the target mark, and the flying body may be unable to implement a desired flight state.

The present invention provides a technique of solving the above-described problem.

### Solution to Problem

One example aspect of the present invention provides a flying body comprising:
a determiner that determines whether to make the flying body hover;
an image capturer that captures a periphery of the flying body;
a recorder that records an image captured by the image capturer; and
a stop controller that, if it is determined to make the flying body hover, stops the flying body using the image recorded in the recorder and an image captured during flight.

Another example aspect of the present invention provides a flying body control apparatus comprising:
a determiner that determines whether to make a flying body hover;
an image receiver that receives an image acquired by capturing a periphery of the flying body;
a recorder that records the image captured by the image capturer; and
a stop controller that, if it is determined to make the flying body hover, stops the flying body using the image recorded in the recorder and an image captured during flight.

Still other example aspect of the present invention provides a control method of a flying body, comprising:
determining whether to make the flying body hover;
capturing a periphery of the flying body;
recording an image captured in the capturing; and
if it is determined to make the flying body hover, stopping the flying body using the image recorded in the recording and an image captured during flight.

Still other example aspect of the present invention provides a flying body control program for causing a computer to execute a method, comprising:
determining whether to make the flying body hover;
capturing a periphery of the flying body;
recording an image captured in the capturing; and
if it is determined to make the flying body hover, stopping the flying body using the image recorded in the recording and an image captured during flight.

### ADVANTAGEOUS EFFECTS OF INVENTION

According to the present invention, it is possible to more reliably make a flying body hover at a desired position.

### BRIEF DESCRIPTION OF DRAWINGS

FIG. 1 is a block diagram showing the arrangement of a flying body according to the first example embodiment of the present invention;

FIG. 2A is a view for explaining the flight conditions of a flying body according to the second example embodiment of the present invention;

FIG. 2B is a view for explaining the flight conditions of the flying body according to the second example embodiment of the present invention;

FIG. 3 is a view for explaining the arrangement of the flying body according to the second example embodiment of the present invention;

FIG. 4 is a view for explaining the arrangement of the flying body according to the second example embodiment of the present invention;

FIG. 5 is a view for explaining the arrangement of the flying body according to the second example embodiment of the present invention;

FIG. 6 is a view for explaining the arrangement of the flying body according to the second example embodiment of the present invention;

FIG. 7 is a view for explaining the arrangement of the flying body according to the second example embodiment of the present invention;

FIG. 8 is a flowchart for explaining the procedure of processing of the flying body according to the second example embodiment of the present invention;

FIG. 9 is a view for explaining the arrangement of a flying body according to the third example embodiment of the present invention;

FIG. 10 is a view for explaining the arrangement of the flying body according to the third example embodiment of the present invention;

FIG. 11 is a flowchart for explaining the procedure of processing of the flying body according to the third example embodiment of the present invention;

FIG. 12 is a flowchart for explaining the procedure of processing of a flying body according to the fourth example embodiment of the present invention;

FIG. 13 is a view for explaining the arrangement of a flying body according to the fifth example embodiment of the present invention;

FIG. 14 is a view for explaining the arrangement of the flying body according to the fifth example embodiment of the present invention; and

FIG. 15 is a view for explaining the arrangement of a flying body control apparatus according to the sixth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

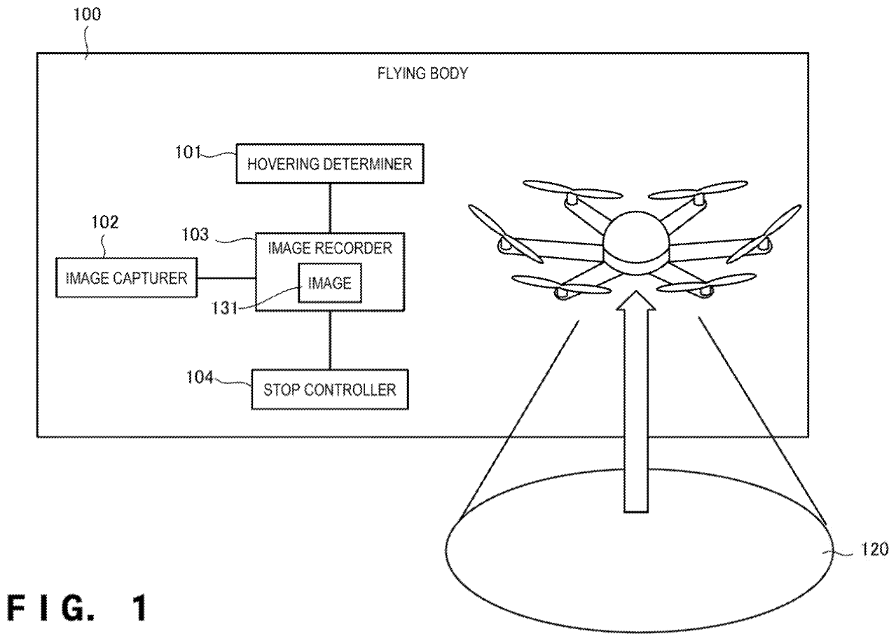

A flying body 100 as the first example embodiment of the present invention will be described with reference to FIG. 1. As shown in FIG. 1, the flying body 100 includes a hovering determiner 101, an image capturer 102, an image recorder 103, and a stop controller 104.

The hovering determiner 101 determines whether to make the flying body hover. The image capturer 102 captures the periphery of the flying body 100. The image recorder 103 records an image 131 captured by the image capturer 102. If it is determined to make the flying body 100 hover, the stop controller 104 makes the flying body 100 stop in the air using image recorded in the image recorder 103 and images captured during the flight.

According to this example embodiment, it is possible to make the flying body hover at an accurate position by a simple method.

### Second Example Embodiment

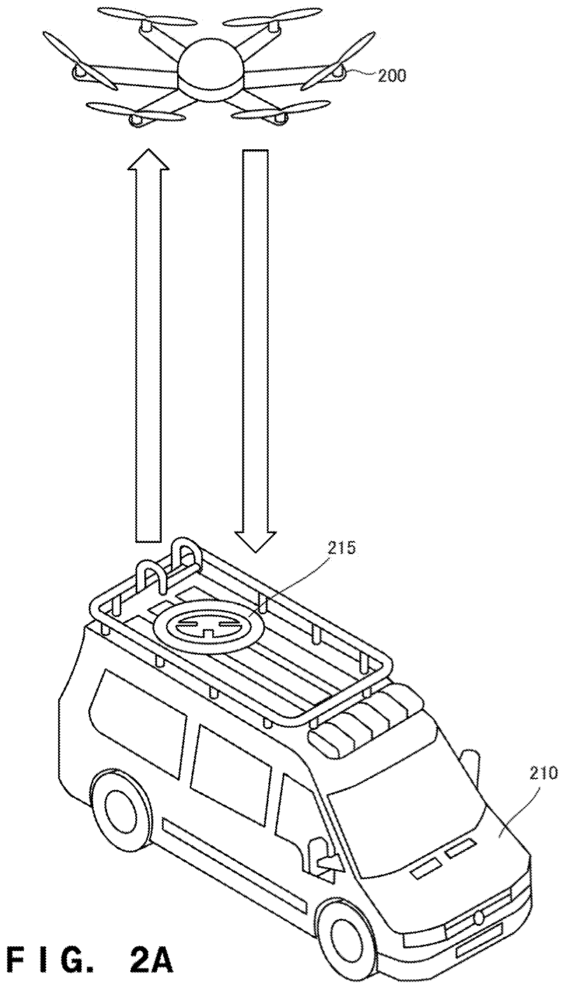

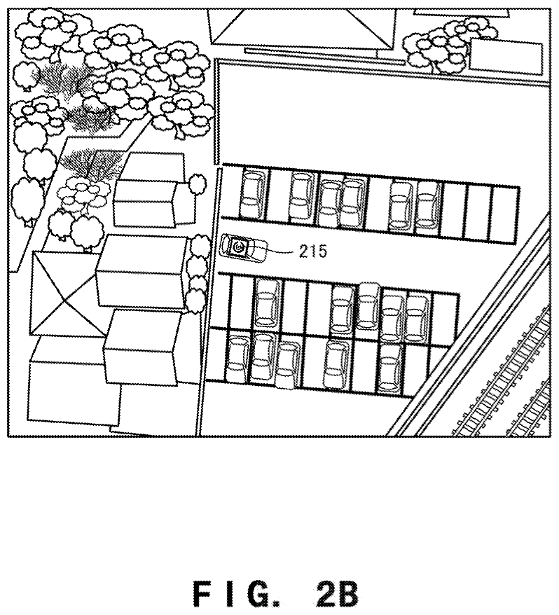

A flying body according to the second example embodiment of the present invention will be described next with reference to FIGS. 2A to 5. FIG. 2A is a view for explaining the takeoff/landing state of a flying body 200 according to this example embodiment. To dispatch the flying body 200 to a disaster area, for example, a vehicle 210 is stopped between buildings, and the flying body 200 is caused to take off/land from/to a target mark 215 provided on the roof of the vehicle.

At the time of hovering, a deviation of several m occurs in flight control relying on a GPS (Global Positioning System). In addition, even if an image obtained by capturing the target mark 215 is to be used, as shown in FIG. 2B, from a high altitude (for example, 100 m or more), the target mark 215 cannot be seen well, or a recognition error may occur because the target mark is disturbed by patterns or shapes of buildings on the periphery.

This example embodiment provides a technique for making the flying body 200 hover at a desired position without resort to the target mark.

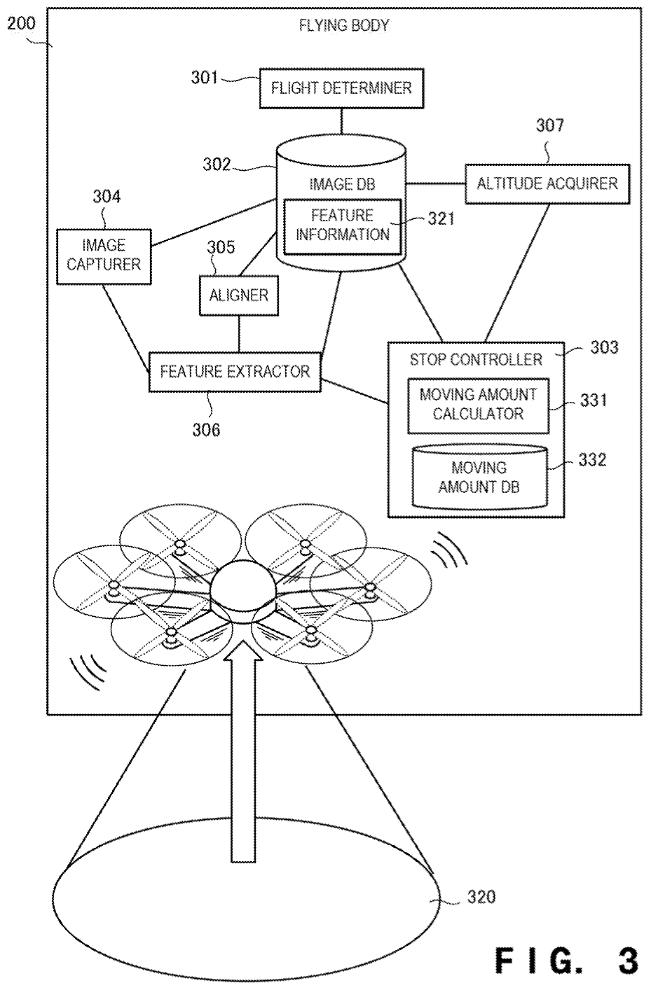

FIG. 3 is a view showing the internal arrangement of the flying body 200. The flying body 200 includes a flight determiner 301, an image database 302, a stop controller 303, an image capturer 304, an aligner 305, a feature extractor 306, and an altitude acquirer 307.

The flight determiner 301 determines whether to make the flying body 200 hover. More specifically, the flight determiner 301 determines whether a hovering instruction is received from a drone pilot via an operation device called a transmitter for radio-controlled toys. The flight determiner 301 may determine, in accordance with an instruction from the drone pilot, whether to make the flying body 200 hover.

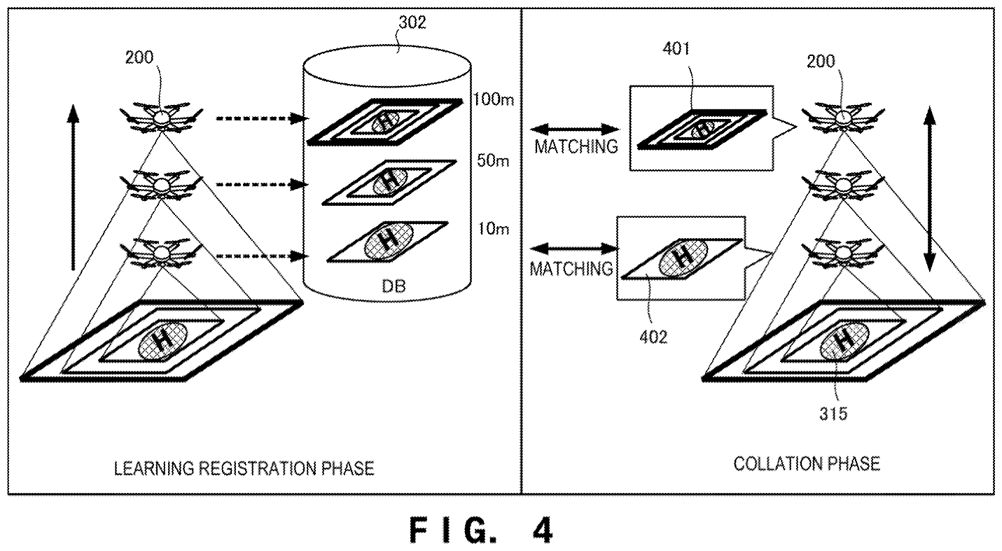

As shown in FIG. 4, if it is determined that the flying body 200 is taking off and ascending, the image database 302 shifts to a learning registration phase, causes the image capturer to capture a lower image at a predetermined altitude, and records the captured lower image (for example, a ground image or a sea image) as a leaning image. In addition, if it is determined to make the flying body 200 hover, the stop controller 303 performs matching between the contents recorded in the image database 302 and images 401 and 402 captured during the flight, and makes the flying body 200 hover at a desired altitude.

At the time of takeoff/ascent, the image capturer 304 faces directly downward and captures/learns images. At the time of horizontal movement after that, the image capturer 304 captures images in arbitrary directions. At the time of hovering, the image capturer 304 is directed downward to capture images, and matching with the recorded learning image is performed, thereby making the flying body hover at the recording position of the learning image.

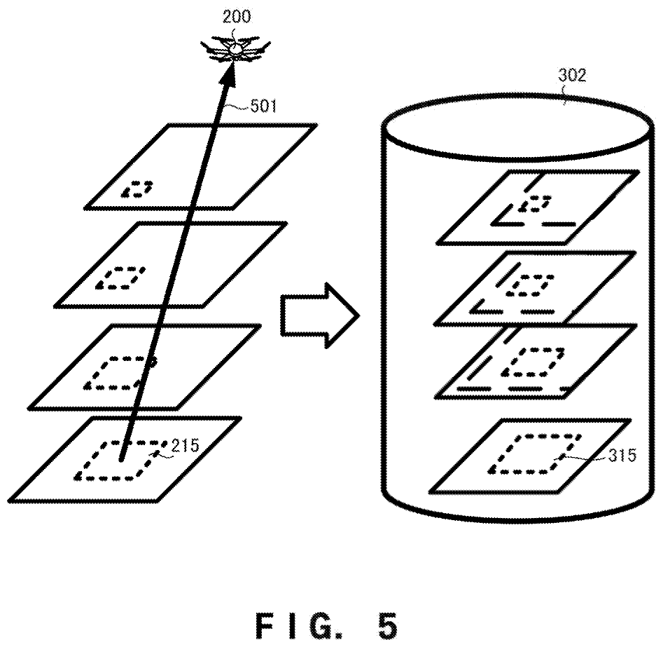

As shown in FIG. 5, the aligner 305 performs alignment of lower images to absorb a position deviation 501 of the flying body 200 during takeoff/ascent, and then records the images in the image database 302. That is, the lower images are cut such that the takeoff point 315 is always located at the center. This makes it possible to do hovering above the takeoff point 315 at any altitude.

The altitude acquirer 307 acquires flight altitude information concerning the altitude at which the flying body 200 is flying. The image database 302 records the flight altitude information in association with a captured image (a lower image here). In addition, the image database 302 records a plurality of lower images corresponding to different image capturing altitudes.

The feature extractor 306 extracts a plurality of feature points from an image recorded in the image database 302, and records the extracted feature points as feature information 321 in the image database 302. A technique of extracting a feature point from an image for matching is disclosed in ORB: an efficient alternative to SIFT or SURF (Ethan Rublee Vincent Rabaud Kurt Konolige Gary Bradski). In addition, in an image captured during hovering, a feature point is extracted only from an object having a small moving vector, and an object having a large moving vector is excluded from the extraction target of the feature point.

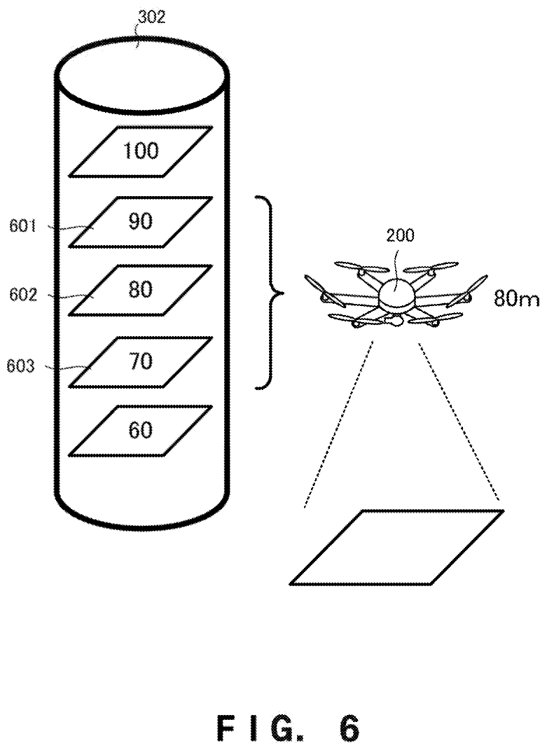

The stop controller 303 compares feature points recorded in the image database 302 with feature points extracted from lower images captured during hovering. In accordance with flight altitude information, the stop controller 303 selects, from the image database 302, contents for which matching with images captured during hovering should be performed. As shown in FIG. 6, as images to be compared with images (or feature points) captured during hovering to make the flying body 200 hover at the position of an altitude of 80 m, three lower images 601 to 603 (or feature points) recorded in correspondence with altitudes of 90 m, 80 m, and 70 m are selected.

At this time, if the altitude to hover can be acquired from the altitude acquirer 307, the stop controller 303 selects an image or a feature point to be read from the image database 302 using the altitude as reference information.

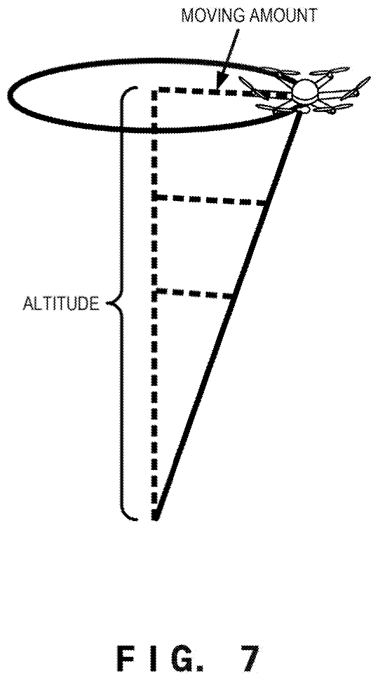

The stop controller 303 performs matching of the feature points, and performs guidance in a moving amount according to the altitude any time, thereby implementing accurate hovering. More specifically, a moving amount calculator 331 refers to a moving amount database 332, and derives the moving amount of the flying body 200 based the deviation between a feature point recorded in the image database 302 and a feature point extracted from an image captured during hovering, and a measured altitude. As shown in FIG. 7, even if the number of pixels corresponding to the deviation of the same feature point does not change, the flying body needs to be moved large as the altitude becomes high. Note that an invisible geofence may virtually be set by the GPS at a position corresponding to a radius of 5 m with respect to the landing point as the center, and control may be performed to do hovering without crossing over the geofence. In addition, a feature point that moves largely in a video captured during hovering may be excluded from the matching target.

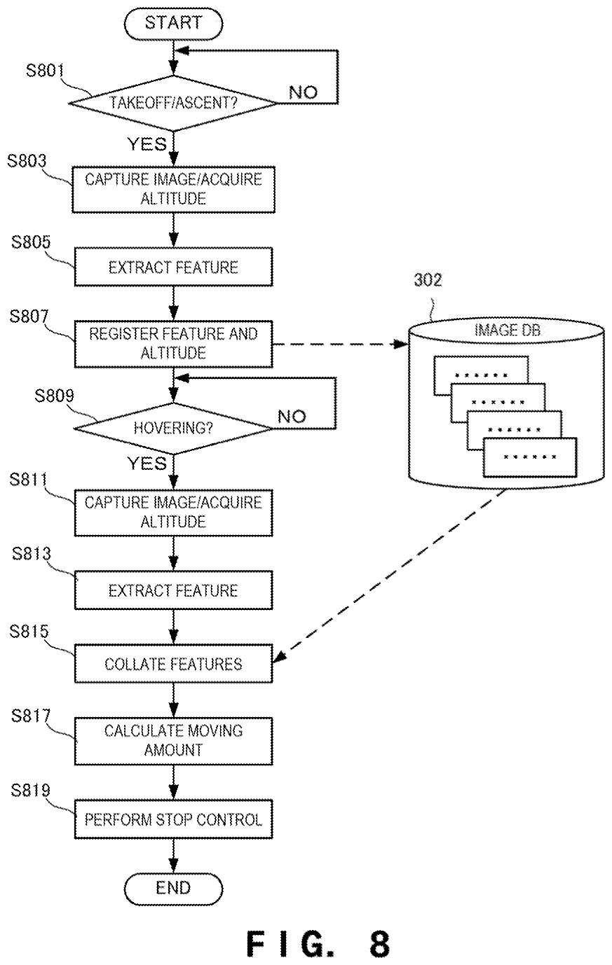

FIG. 8 is a flowchart showing the procedure of processing performed in the flying body 200 according to this example embodiment. First, in step S801, the flight determiner 301 determines whether the flying body is taking off and ascending. In a case of takeoff/ascent, the process advances to step S803, the image capturer 304 captures a lower image, and at the same time, the altitude acquirer 307 acquires the altitude.

In step S805, the feature extractor 306 extracts a feature point from the captured lower image. The process advances to step S807, and the feature point is further recorded in the image database 302 in correspondence with the altitude information. At this time, the aligner 305 performs the above-described alignment processing.

Next, in step S809, the flight determiner 301 determines whether to make the flying body 200 hover. The process advances to step S811 to capture a lower image and record it in the image database 302. At the same time, altitude information is acquired. In step S813, the feature extractor 306 extracts a feature point from the image captured in step S811. After that, in step S815, based on the acquired altitude information, the feature extractor 306 selects a feature point to be compared from the feature points registered in the image database 302, and compares the feature point with the feature point extracted in step S813.

In step S817, the moving amount calculator 331 calculates the moving amount of the flying body 200 from the position deviation amount (the number of pixels) of the feature point. The process advances to step S819, and the stop controller 303 moves the flying body 200 by a small amount in accordance with the calculated moving amount, thereby making the flying body fly at a predetermined position in the air in an almost stop state.

As described above, according to this example embodiment, it is possible to accurately perform takeoff/landing even in a place, for example, between buildings, where it is difficult to use the GPS. In this example embodiment, feature points are extracted from lower images, and the deviation from the hovering position is detected by comparing the feature points. However, the present invention is not limited to this, and the deviation from the hovering position may be detected by comparing the lower images themselves.

### Third Example Embodiment

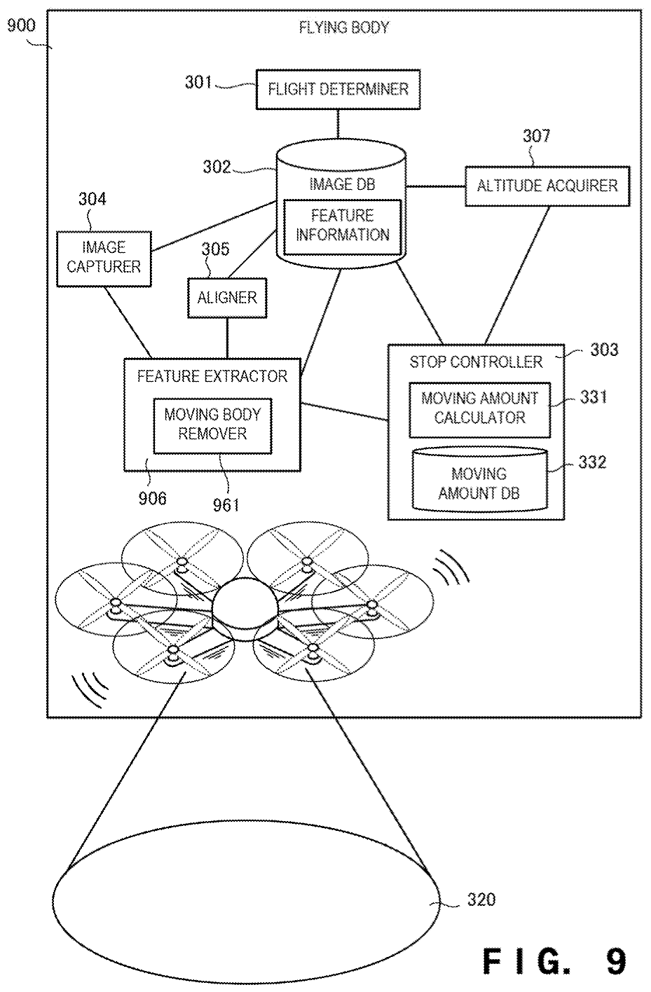

A flying body 900 according to the third example embodiment of the present invention will be described next with reference to FIG. 9. FIG. 9 is a view for explaining the internal arrangement of the flying body 900 according to this example embodiment. The flying body 900 according to this example embodiment is different from the above-described second example embodiment in that a feature extractor 906 includes a moving body remover 961. The rest of the components and operations is the same as in the second example embodiment. Hence, the same reference numerals denote similar components and operations, and a detailed description thereof will be omitted.

The moving body remover 961 compares a plurality of images (frames) captured and recorded in an image database 302 while ascending at the time of takeoff, and calculates the moving vectors of feature points between the frames. That is, if an object included in the plurality of lower images captured during takeoff/ascent of the flying body 900 moves in a direction other than a radial direction when viewed from the image center along with the elapse of time in the images, the object is determined as a moving body and excluded from the extraction target of the feature point.

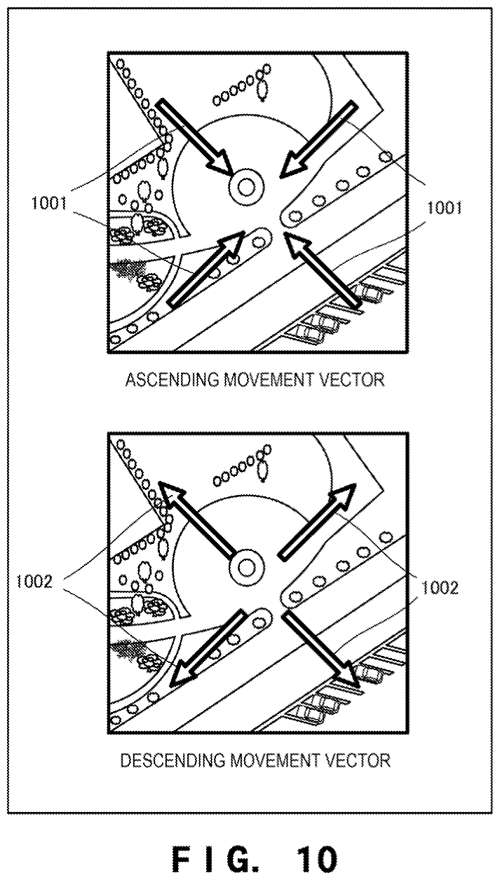

At the time of ascent, feature points with vectors other than ascending movement vectors 1001 directed to the image center, as shown in FIG. 10, are excluded from feature points to be recorded as a moving body such as a vehicle or a human, which is not fixed as the background.

On the other hand, at the time of descent as well, feature points with vectors other than descending movement vectors 1002 directed radially outward from the image center are excluded from feature points to be compared as a moving body such as a vehicle or a human, which is not fixed as the background.

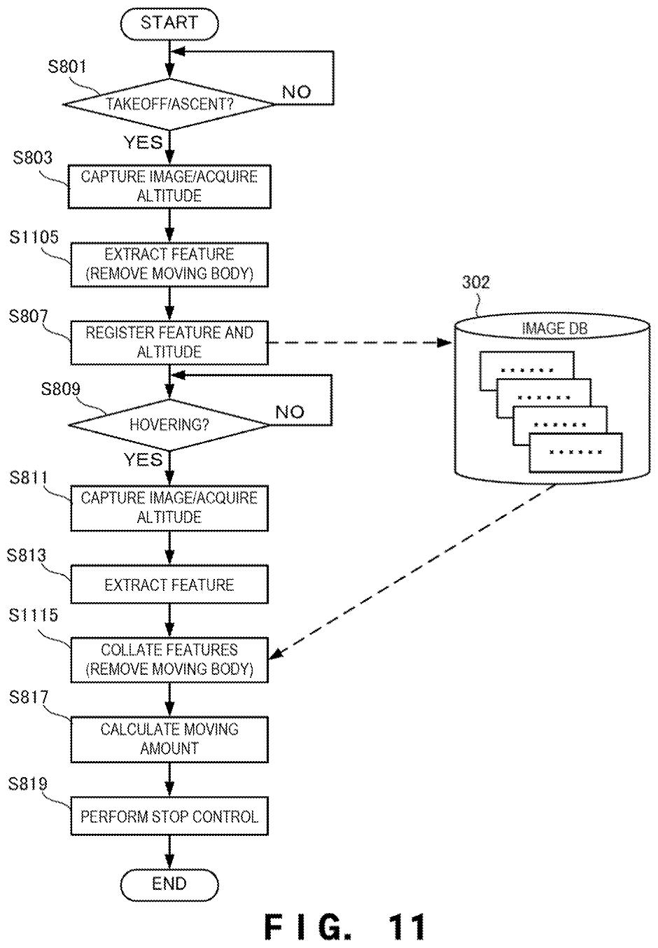

FIG. 11 is a flowchart showing the procedure of processing performed in the flying body 900 according to this example embodiment. This flowchart is the same as the flowchart of FIG. 8 except that moving body removing processing (vector processing) is performed in steps S1105 and S1115, and a description thereof will be omitted.

As described above, according to this example embodiment, learning and matching can accurately be performed by removing a moving body, and the flying body can thus accurately be made to hover at a predetermined position.

### Fourth Example Embodiment

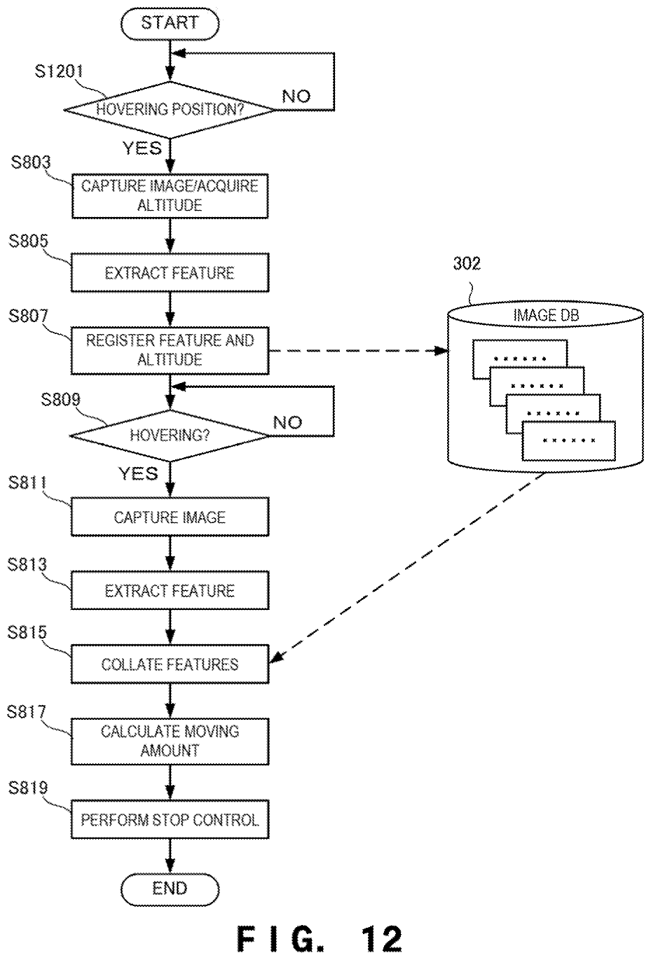

A flying body according to the fourth example embodiment of the present invention will be described next. In the above-described example embodiments, flight position control is performed using lower images recorded at the time of takeoff/ascent and lower images captured during hovering. In this example embodiment, furthermore, hovering control is performed using preliminary image information recorded in a recorder in advance at another timing. More specifically, as shown in FIG. 12, at a position designated as a hovering position by a drone pilot (step S1201), image capturing and altitude acquisition are performed (step S803), and stop control may be performed using the images captured there and the altitude (step S819).

In addition, hovering control may be performed using images registered in an image database 302 in advance before flight. Alternatively, feature points may be extracted from image data accessible on the Internet, and hovering control may be performed using the feature points. If the hovering altitude is low, an image of a target marker, which is registered in advance, may be used. Images to be subjected to matching may be switched in accordance with the altitude of hovering. The altitude at which the image is switched may be decided from the angle of view of a camera and the size of the target marker, or may be decided from the number of feature points included in an image captured at the altitude of hovering. That is, if the number of feature points included in a lower image captured at the altitude of hovering is small, an image in which the number of feature points is large may be used instead.

### Fifth Example Embodiment

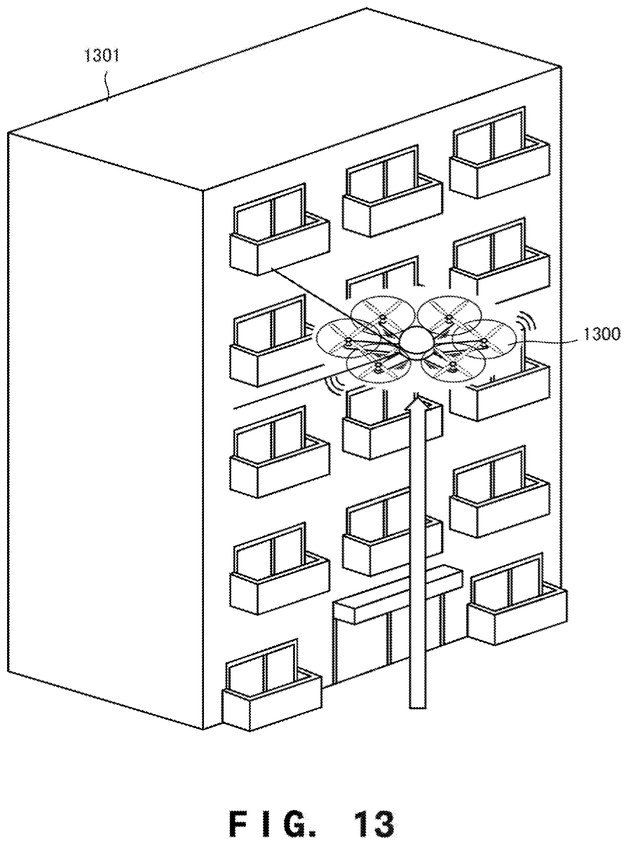

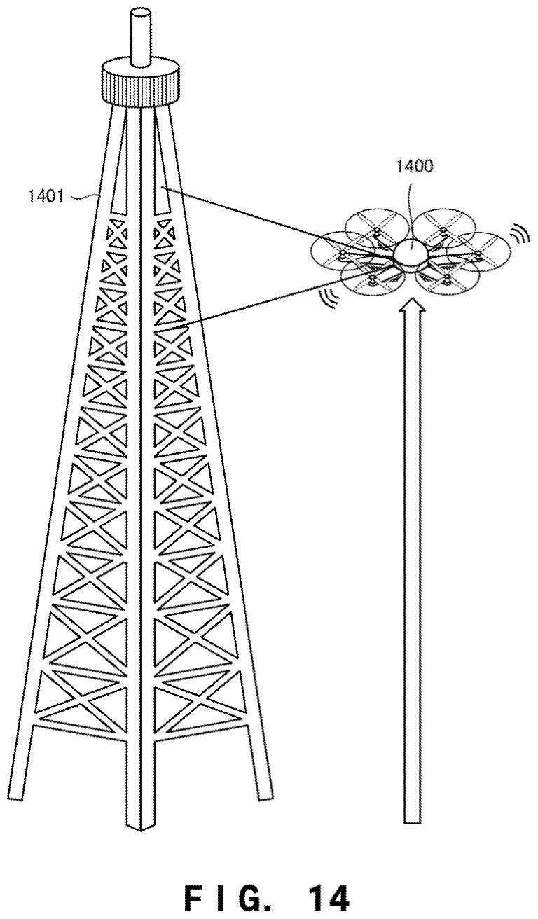

A flying body according to the fifth example embodiment of the present invention will be described next. In the above-described example embodiments, flight position control is performed using lower images recorded at the time of takeoff/ascent and lower images captured during hovering. In this example embodiment, furthermore, hovering control is performed using an image on the front side of the flying body. More specifically, as shown in FIG. 13, a front image obtained by capturing a window of an apartment 1301 or a feature point in the image may be recorded in an image database 302 in association with, for example, a room number, and a flying body 1300 may be made to hover at a predetermined position in accordance with an instruction of a room number. As shown in FIG. 14, a front image obtained by capturing a steel tower 1401 may be recorded in the image database 302 in association with altitude information, and a flying body 1400 may be made to hover at a predetermined position using the front image or feature point read out in accordance with a designation of an altitude from a drone pilot.

### Sixth Example Embodiment

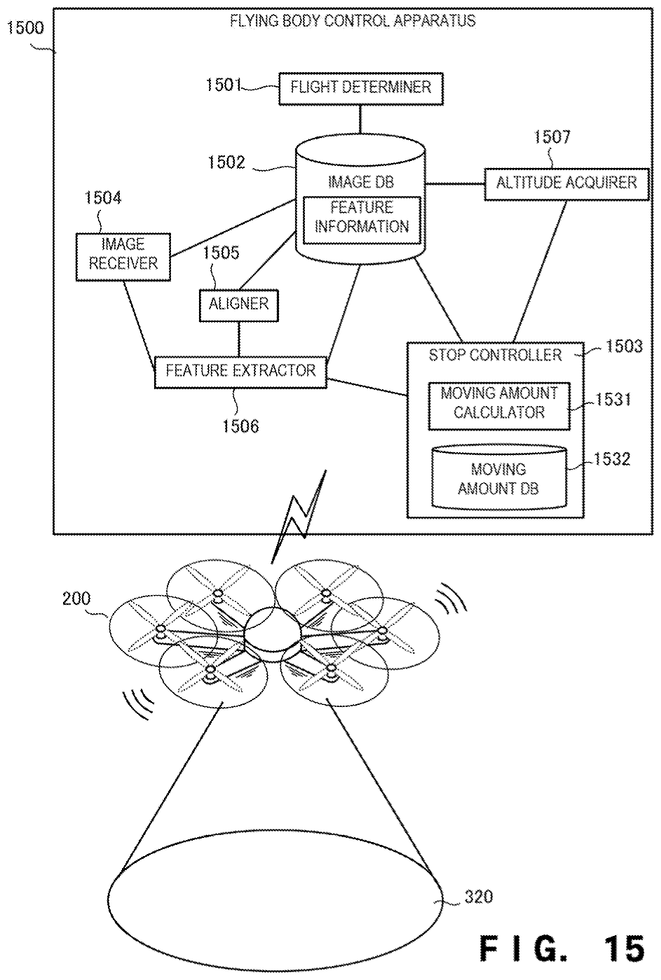

A flying body control apparatus 1500 according to the sixth example embodiment of the present invention will be described next with reference to FIG. 15. FIG. 15 is a view for explaining the internal arrangement of the flying body control apparatus 1500 (so-called transmitter for radio-controlled toys) according to this example embodiment.

The flying body control apparatus 1500 according to this example embodiment includes a flight determiner 1501, an image database 1502, a stop controller 1503, an image receiver 1504, an aligner 1505, a feature extractor 1506, and an altitude acquirer 1507.

The flight determiner 1501 determines whether to make a flying body 200 hover. More specifically, the flight determiner 1501 determines whether a hovering instruction is received from a drone pilot via an operation device called a transmitter for radio-controlled toys. The flight determiner 1501 may determine, in accordance with an instruction from the drone pilot, whether to make the flying body 200 hover.

If it is determined that the flying body 200 is taking off and ascending, the image database 1502 shifts to a learning registration phase, causes an image capturer to capture an image at a predetermined altitude, and records the captured image (a ground image, a sea image, or a front image) as a leaning image. In addition, if it is determined to make the flying body 200 hover, the stop controller 1503 shifts to a collation phase, and makes the flying body 200 hover at a desired altitude using the contents recorded in the image database 1502 and the images captured during the flight.

The image receiver 1504 receives the captured image. The aligner 1505 performs alignment of lower images to absorb the position deviation of the flying body 200 during takeoff/ascent, and then records the images in the image database 1502. That is, the lower images are cut such that the takeoff point is always located at the center. This enables hovering above the takeoff point at any altitude.

The altitude acquirer 1507 acquires flight altitude information concerning the altitude at which the flying body 200 is flying. The image database 1502 records the flight altitude information in association with a captured image. In addition, the image database 1502 records a plurality of images corresponding to different image capturing altitudes.

The feature extractor 1506 extracts a plurality of feature points from an image recorded in the image database 1502, and records the extracted feature points as learning information in the image database 1502.

The stop controller 1503 compares feature points recorded in the image database 1502 with feature points extracted from images captured during hovering. In accordance with flight altitude information, the stop controller 1503 selects, from the image database 1502, contents for which matching with images captured during hovering should be performed. At this time, if the altitude to hover can be acquired from the altitude acquirer 1507, the stop controller 1503 selects an image or a feature point to be read from the image database 1502 using the altitude as reference information.

The stop controller 1503 performs matching of the feature points and performs guidance in a moving amount according to the altitude any time, thereby implementing accurate hovering. More specifically, a moving amount calculator 1531 refers to a moving amount database 1532, and derives the moving amount of the flying body 200 based the deviation between a feature point recorded in the image database 1502 and a feature point extracted from an image captured during hovering, and a measured altitude.

According to this example embodiment, the flying body can accurately be made to hover at a desired position.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. A flying body comprising:
a determiner that determines whether to make the flying body hover;
an image capturer that captures a periphery of the flying body;
a recorder that records an image captured by the image capturer; and
a stop controller that, if the determiner determines to make the flying body hover, stops the flying body in air using the image recorded in the recorder and an image captured during flight.

2. The flying body according to claim 1, further comprising an altitude acquirer that acquires flight altitude information,
wherein the recorder records the flight altitude information in association with the image.

3. The flying body according to claim 2, wherein the recorder records a plurality of images corresponding to different image capturing altitudes in association with the flight altitude information, and
wherein the stop controller selects the image to be used from the recorder in accordance with the flight altitude information.

4. The flying body according to claim 1, wherein the recorder records a feature point extracted from the image, and
wherein the stop controller compares the feature point recorded in the recorder with the feature point extracted from the image captured during the flight, and makes the flying body stop in the air.

5. The flying body according to claim 4, further comprising a moving body remover that, if the image is a lower image obtained by capturing a lower side of the flying body, and an object included in the lower image moves from an image center in a direction other than a radial direction along with an elapse of time, determines the object as a moving body and excludes the object from an extraction target of the feature point.

6. The flying body according to claim 1, wherein the recorder records a front image of the flying body captured by the image capturer, and
wherein, if the determiner determines to make the flying body hover, the stop controller stops the flying body using the front image recorded in the recorder and the front image captured during the flight.

7. The flying body according to claim 1, wherein the stop controller performs guidance in a moving amount according to an altitude using a lower image recorded in the recorder at every predetermined altitude and the lower image captured during the hovering.

8. A flying body control apparatus comprising:
a determiner that determines whether to make a flying body hover;
an image receiver that receives an image acquired by capturing a periphery of the flying body;
a recorder that records the image received by the image receiver; and
a stop controller that, if the determiner determines to make the flying body hover, stops the flying body using the image recorded in the recorder and an image captured during flight.

9. A control method of a flying body, the control method comprising:
determining whether to make the flying body hover;
capturing a periphery of the flying body;
recording an image captured in the capturing; and
if the determining determines to make the flying body hover, stopping the flying body in air using the image recorded in the recording and an image captured during flight.

10. (canceled)
